(19) United States
(12) Patent Application Publication
(10) Pub. No.: US 2009/0071663 A1
(43) Pub. Date: Mar. 19, 2009

(54) Apparatus for inhibiting the propagation of wilderness fires

(76) Inventor: Charles Chipps, West Palm Beach, FL (US)

Correspondence Address: MARK D. BOWEN, ESQ.;MALIN HALEY DIMAGGIO BOWEN & LHOTA, P.A., 1936 S. ANDREWS AVENUE, FT. LAUDERDALE, FL, 33316, US

(21) Appl. No.: 11/901,076

(22) Filed: Sep. 13, 2007

(51) Int. Cl. A62C 2/00

(52) U.S. Cl. 169/48

(57) ABSTRACT

An apparatus and method for preventing the propagation of an uncontrolled fire in wilderness areas by means of creating a fire break by the controlled burning and subsequent extinguishing of all flames, leaving a charred, fuel free path, that prevents a fire from traversing the fire break due to lack of fuel. The apparatus is adapted with high intensity torches, mounted on a moving platform such that the flame intensity, height above ground, and angle relative to the ground are all adjustable by the operator. The front of the moving platform is hitched behind a tractor, bulldozer or the like, for motive power. Behind the torches, a large, heavy roller suspends the rear of the moving platform, and extinguishes the flame created by the torches.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to inhibiting the spread of uncontrolled wilderness fires, and aid in the prevention of their occurrence, and, more particularly to an apparatus and method for creating a fire break and/or for clearing land by automated controlled burning of overgrown areas.

2. Description of Related Art

Wild fires are capable of potentially disastrous effects, including damage to the environment, property, and loss of life. As a result, wild fire management concepts have evolved in an effort to reduce the risk of wild fires. In addition, fire fighting techniques have been adapted to contain and extinguish fires in order to minimize these risks. Once technique commonly used to reduce the risk of wild fires, as well as contain and extinguish actual fires involves controlled burning. Controlled burning involves use of a controlled fire to burn and thus consume the potential fuel for an uncontrolled wilderness fire.

As far back as ancient times, the practice of burning underbrush has been used to prevent fires from occurring spontaneously, as can happen when local climactic conditions, including extended periods of low relative humidity for extended periods of time. In recent times the method has been utilized to aid in limiting the frequency of wild fires, sometimes intentionally set by a human with mental deficiency, or unintentionally by a careless human. Thus the practice has been for a team of individuals to carry hand held torches, with fuel supplied by fuel tanks carried on their backs to consume, by flame, the vegetation of a given area. Controlled burns have been used in instances where the intent was to lessen the likelihood in occurrence of an unintentional fire, and also to stop the progress, or at least slow down and lessen the intensity of a wilderness fire that has already been ignited, and is spreading over a region. The latter of preceding intents is the most popular use in recent times, however it stands to reason that if this practice could be used more wide scale, and judiciously done at certain intervals of time, that the frequency in occurrence of uncontrolled wilderness fires can be reduced. Unfortunately the current methods require extensive time and man hours. Perhaps the leading cause of a decline in the use of controlled burning in modern times is humankind's fear of fire. Since much wilderness land is lost rapidly and intentionally, because of the peoples consumption of it for habitation and/or resources, so it is important to try to prevent the unfavorable conditions that can lead to even more rapid, and catastrophic destruction to what portion of it that people decide to preserve.

As a result of the limitations, disadvantages, inconvenience, and labor costs associated with conventional controlled burning techniques, there exists a need for an improved apparatus and method for creating regions clear of underbrush and tinder in order minimize the potential and reduce the frequency in occurrence of wilderness fires in a more safe, expedient, and efficient manner.

### BRIEF SUMMARY OF THE INVENTION

The present invention overcomes the limitations and disadvantages present in the art by providing apparatus and a method for creating regions clear of underbrush and tinder in order minimize the potential and reduce the frequency in occurrence of wilderness fires, using a platform or frame having at its forward most position, a provision for attachment and implementation behind a tractor, bulldozer or other land vehicle providing motive power. A number of burner heads or torches are employed as burner elements and are attached to the frame or platform such that they are adjustable for intensity of flame by a control valve located a safe distance ahead of the flames point of incident, and also adjustable for height of burner element relative to the ground, and angular attitude of the flame projection in the horizontal, and vertical planes relative to the ground. A fuel tank to supply the burner elements is mounted to the platform a safe distance ahead of the flames point of incident, from which one or more supply hoses will be routed to the burner element(s) in a path as to preclude the possibility of being scorched through causing a potentially hazardous condition. Positioned at the extreme rear of the platform shall be a cylindrical roller of sufficient diameter and weight to smother, and extinguish the burning underbrush and tender.

The method of operation involves towing the device behind the aforementioned methods of motive power through the desired region to be treated, at such a rate as to effectively eliminate or reduce the volatility of the indigent low lying vegetation. The purpose of operation is to clear low lying vegetation to create a fire break, or alternatively to simply clear the vegetation for any desired purpose. It may become necessary to take preventive measures to insure that the flame be contained between the outermost periphery of the extinguishing element (roller), and that any combustion or remaining live cinders be extinguished by an auxiliary high pressure water source either adapted to the apparatus itself or a follow vehicle. In cases of a gentle breeze, side shields may be used to contain the fire to the roller's path. When wind is to extreme or dry conditions exist the task should not be attempted. This method may be either employed as a preventive measure or employed up-wind of an approaching wild fire to exhaust combustible material that would otherwise fuel the fire.

Accordingly, it is an object of the present invention to provide an apparatus and method for creating regions clear of underbrush and tinder in order minimize the potential and reduce the frequency in occurrence of wilderness fires in a more safe, expedient, and efficient manner.

Another object of the present invention to provide apparatus and method which is both convenient and economical.

Yet another objective of the present invention to provide a device and method for creating regions clear of underbrush and tinder in order minimize the potential destruction and reduce the frequency in occurrence of wilderness fires which includes an immediate snuffing out of the intended flame by utilizing a large diameter, relatively high mass cylindrical roller to smother the flame.

Another object of the invention is to control the efficacy of this process, and accommodate a variety of existing wilderness conditions, by making adjustable the intensity of flame, height of burner element relative to the ground, and angular attitude of the flame projection in the horizontal, and vertical planes relative to the ground, in order to compensate for wind, and conditions of the terrain.

Still another objective is to mechanize and automate the process of creating regions clear of underbrush and tinder in order minimize the wild fire potential by towing a burning apparatus behind a land vehicle thus making it easier and more expedient to utilize controlled burning on a more frequent wide spread basis.

Yet another object of the present invention is to reduce risk to the operator by placing the operator further away and forward of the point of incidence of the object flame, by virtue of the apparatus being behind the tow vehicle.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

FIG. 1 illustrates a front elevational view of the apparatus for clearing wilderness regions of underbrush and tender, being the potential fuel sources for uncontrolled fires;

FIG. 2 illustrates a right side elevational view thereof,

FIG. 3 demonstrates a top plan view of the apparatus as shown in FIG. 1;

FIG. 4 shows the front elevational view with the fuel tank removed;

FIG. 5 is a rear perspective view illustrating the apparatus being towed by a tractor; and

FIG. 6 is a side view illustrating the apparatus in operation.

### DETAILED DESCRIPTION OF THE INVENTION

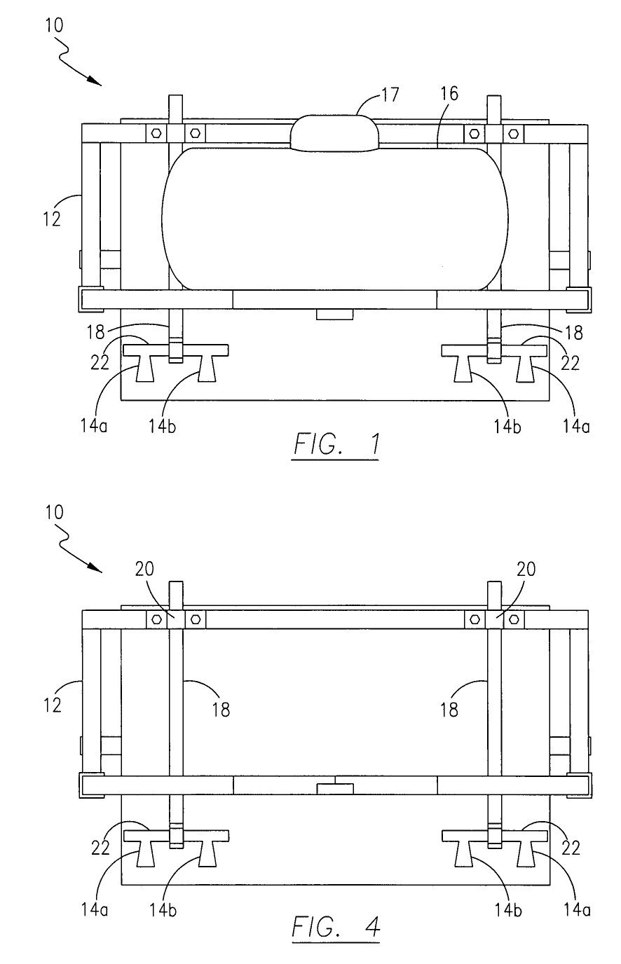

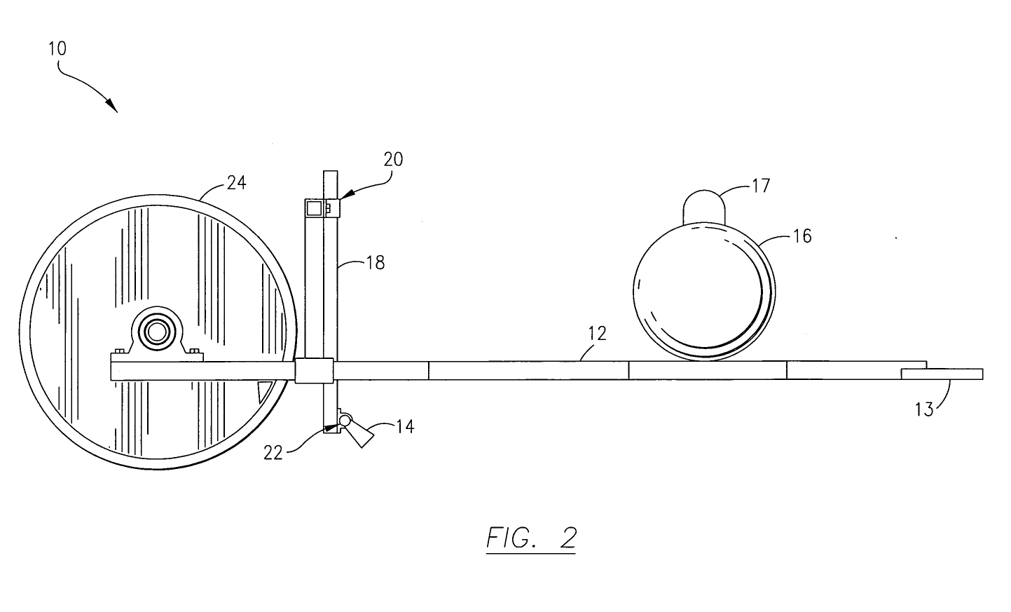

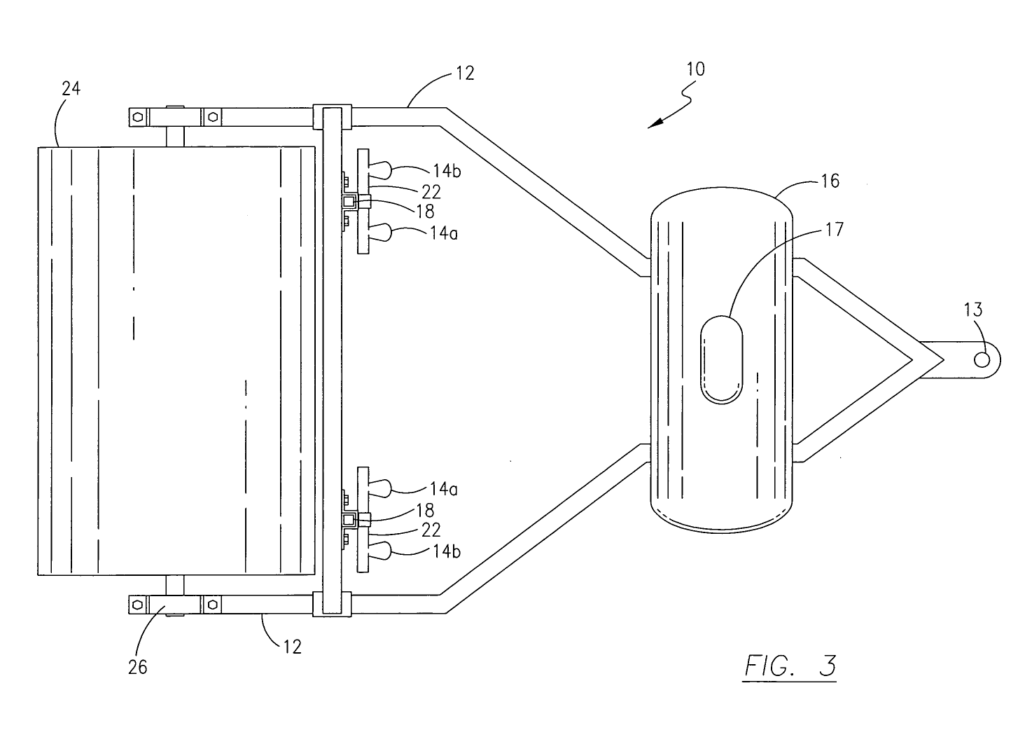

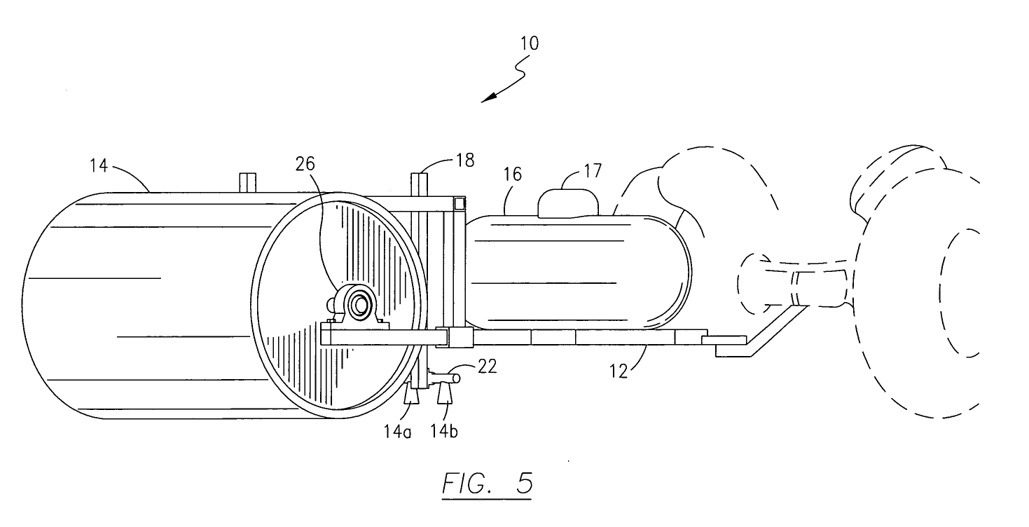

With reference now to the drawings, FIGS. 1-5 depict a preferred embodiment of an apparatus, generally referenced as 10, for clearing wilderness regions of underbrush and tinder. As best seen in FIGS. 1-3, apparatus 10 includes platform or frame 12 adapted with a plurality of flame producing elements or burners 14 capable of generating an intense flame output. Frame 12 includes a front end 13 adapted for connection to a land vehicle, such as by connection to a trailer hitch or ball existing on the rear of the vehicle to facilitate towing of apparatus 10 as best illustrated in FIGS. 2 and 3. Flame producing elements 14 are in fluid communication with a fuel storage container 16 containing fuel, such as propane or any other suitable fuel, by suitable fuel supply lines such that flame producing elements 14 are capable of producing an intense and directed flame. Fuel storage container 16 may further function as a mounting structure for a control valve 17 that facilitates or regulates adjustment of fuel flow.

A suitable plurality of flame producing elements should be disposed in spaced relation along the width of frame 12. In a preferred embodiment, a pair of flame producing elements, referenced as 14a and 14b, are mounted to a vertically adjustable, generally vertically disposed, bar 18 adjustably fixed to a clamp and bracket assembly 20 secured to a frame 12. Each of the flame producing elements 14a and 14b, may be pivotally mounted to opposing ends of a round bar 22 to facilitate angular adjustment relative to the ground. FIG. 1 depicts two identical sets of flame producing elements mounted side by side. Bar 18 is preferably vertically adjustable so as to enable raising or lowering flame producing elements 14a and 14b relative to the ground. By way of example, bar 18 may be fastened to the frame 12 clamps to facilitate simple and rapid vertical height adjustment in the field. The present invention, however, contemplates any suitable fastening mechanism to facilitate such adjustment. Vertical adjustment is considered important as the present invention is suitable for use on various terrain under in various conditions and environments. In addition, bar 18 may be generally cylindrical thereby allowing for rotational adjustment thereof so as to enable rotationally directional adjustment of flame producing elements 14. Flame producing elements 14 function to ignite, burn, and scorch underling underbrush and tinder in a controlled manner thereby exhausting the fuel potential of said underbrush and tinder such that it is effectively no longer capable of supporting a fire.

Once flame producing elements 14 ignite the underbrush and tinder in a controlled manner any lingering fire must be extinguished so as to prevent the fire from spreading. Accordingly, frame 12 has a trailing end adapted with a cylindrical roller 24 mounted transversely at the rear most end of the device to extinguishes the burning substrate. Cylindrical roller 24 is preferably rotatably secured to frame 12 by a shaft connected to pillow block type radial ball bearings 26 affixed to frame 12. Cylindrical roller 24 is preferably fabricated from steel and may include additional internal weighting to insure that any fire is sufficiently extinguished. In an alternate embodiment, additional weighting may be affixed to frame 12. As should now be apparent, cylindrical roller 24 functions to extinguish any fire generated by flame producing elements 14 by smothering the fire and thereby depriving the fire of the oxygen needed to burn.

Fuel storage container 16 and associated regulator, control valve, ignition control, and other safety devices mounted thereto, generally referenced as 17, will be located an adequate distance ahead of the combustion region, namely ahead of flame producing elements 14. In an alternate embodiment, apparatus 10, and particularly frame 12 is adapted with wind deflection shields on opposing sides thereof to prevent fire spreading during periods of operation in breezy conditions. Apparatus 10 can be manufactured in a variety of sizes to satisfy the demands of terrain, and thus may be fabricated with a narrow width for use in dense forest regions or fabricated with a wider width to cover more wide open and/or flatter areas. Apparatus 10 may further be configured to elevate cylindrical roller 24 above the ground with pneumatic tires for transport over highways.

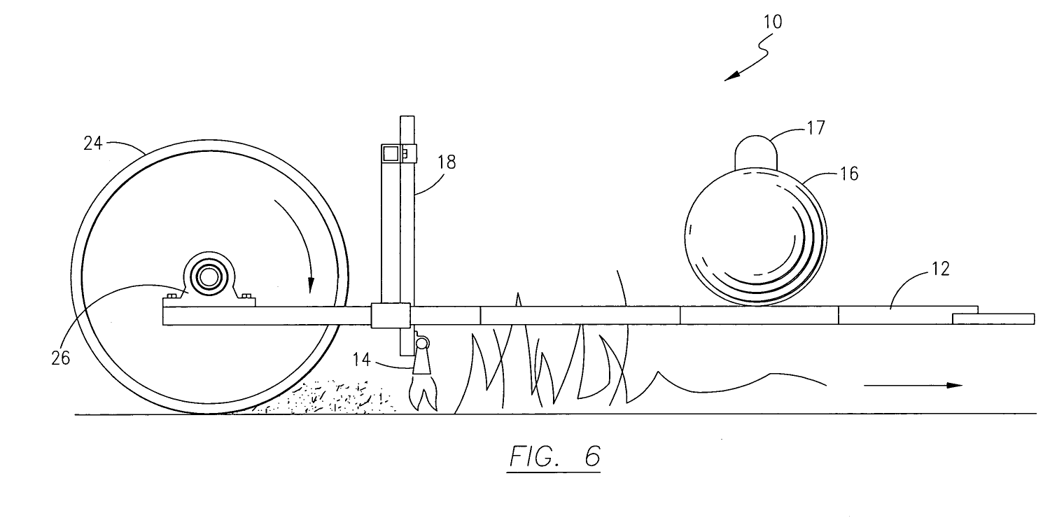

For a more complete understanding of the invention and its method of operation the present invention will be discussed, with attention also drawn to FIGS. 5 and 6. Apparatus 10 is primarily suited for clearing wilderness regions of underbrush and tender. The under bush can be any dry grass, leaves, pine needles, twigs, sapling trees etc., but generally nothing larger than the tow vehicle can easily push over. In dense wooded areas a path or even a shallow trench is dug to provide fire breaks, and maximum effectiveness will only be achieved if these trails are kept clear of the larger vegetation, and as to not inhibit the passage of this apparatus. As the flame producing elements 14 are ignited, and the process begins any desired adjustment is made to control valve 17 located on fuel tank 16 to adjust the intensity of the flame generated by burner elements 14 to a desired level. In addition, flame producing elements 14 may be vertically adjusted to suit the vegetation growth by loosening clamp and bracket assembly 20 and sliding either up or down the element support bar 18 and re-tightening clamp 20. As noted above, the whole support bar 18 is generally cylindrical to facilitate rotation thereof within clamp assembly to provide for angular adjustment in the vertical plane. With all adjustments complete the device 10 is pulled by the tow vehicle over the desired region. Forward speed is then adjusted together with flame intensity, to provide the optimum rate of combustion of the indigenous vegetation. Finally cylindrical roller 24 smothers the live cinders, and ends the combustion cycle thereby neutralizing or substantially reducing the fuel potential of the indigenous vegetation. The substrate left behind is less volatile, and is less conducive to the propagation of flames. It is furthermore conducive and fertile for grasses to grow, which aids in the prevention of soil erosion, and as well provides some of the indigenous animal, and insect life with food. The illustrations and examples provided herein are for explanatory purposes and are not intended to limit the scope of the appended claims.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. An apparatus for creating a fire break in wilderness regions by controlled burning and extinguishing of underbrush, said apparatus comprising:
a moving platform having a front end adapted for connection to a land vehicle, a rear end, and an intermediate portion disposed between said ends;
a fuel container affixed to said platform proximal said front end;
at least one burner connected to said platform intermediate portion, said at least one burner in fluid communication with said fuel container;
means for delivering and regulating the flow of fuel between said fuel container and said at least one burner;
said rear end including means for extinguishing fire;
whereby said moving platform functions to burn and extinguish underbrush while being towed by a land vehicle.

2. An apparatus according to claim 1, further including means for positional adjustment of said at least one burner.

3. An apparatus according to claim 2, wherein said means for positional adjustment provides for directional adjustment of said at least one burner.

4. An apparatus according to claim 2, wherein said means for positional adjustment provides for elevational adjustment of said at least one burner.

5. An apparatus according to claim 2 wherein said means for positional adjustment provides for lateral adjustment of said at least one burner.

6. An apparatus for creating a fire break in wilderness regions by controlled burning and extinguishing of underbrush, said apparatus comprising:
a moving platform having a front end adapted for connection to a land vehicle, a rear end, and an intermediate portion disposed between said ends;
a fuel container affixed to said platform proximal said front end;
a plurality of burners, including first and second pairs of laterally spaced burners, connected to said platform intermediate portion, each of said plurality of burners in fluid communication with said fuel container;
said first and second pairs of burners adjustably connected to said platform such that each of said first and second pairs of burners may be positionally adjusted and fixed at a predetermined elevation, lateral position, and angular direction with respect to a vertical plane;
each of said plurality of burners pivotally adjustable with respect to a horizontal plane;
means for delivering and regulating the flow of fuel between said fuel container and said plurality of burners;
a cylindrical roller mounted transversely to said platform proximal the rear end thereof for extinguishing fire by smothering contact;
whereby said moving platform functions to burn and extinguish underbrush while being towed by a land vehicle.
